(19) United States
(12) Patent Application Publication
(10) Pub. No.: US 2010/0163804 A1
(43) Pub. Date: Jul. 1, 2010

(54) METHOD AND SYSTEM FOR SUPPLYING SYNTHESIS GAS

(76) Inventor: Hubert Willem SCHENCK, Pernis (NL)

Correspondence Address: SHELL OIL COMPANY, P O BOX 2463, HOUSTON, TX, 772522463, US

(21) Appl. No.: 12/649,128

(22) Filed: Dec. 29, 2009

Related U.S. Application Data
(60) Provisional application No. 61/141,267, filed on Dec. 30, 2008.

(51) Int. Cl. C01B 3/22; B01J 19/00

(52) U.S. Cl. 252/373; 422/188

(57) ABSTRACT

A method for supplying synthesis gas comprising reacting a carbonaceous feed with an oxidant, to generate synthesis gas; forwarding all or part of the generated synthesis gas to an underground storage location, to generate a synthesis gas buffer; and retrieving synthesis gas from the underground storage location and supplying the retrieved synthesis gas to a downstream processing unit, which downstream processing unit is substantially continuously converting synthesis gas.

Conveniently the downstream processing unit can comprise a water-gas shift unit and the invention further provides a system for supplying synthesis gas comprising: a gasification unit, for generating synthesis gas from a carbonaceous feed and an oxidant, that is at least directly or indirectly connected to an underground storage location; an underground storage location, for generating a synthesis gas buffer, that is at least connected directly or indirectly to the gasification unit and at least connected directly or indirectly to a water-gas shift unit; and a water-gas shift unit, for generating a shifted synthesis gas, that is at least connected directly or indirectly to the underground storage location.

This application claims the benefit of U.S. Provisional Application No. 61/141,267 filed Dec. 30, 2008, which is incorporated herein by reference.

### FIELD OF THE INVENTION

This invention relates to a method and system for supplying synthesis gas.

### BACKGROUND OF THE INVENTION

Synthesis gas, also referred to as syngas, is a gas that comprises hydrogen and carbon monoxide. In addition, synthesis gas may comprise carbon dioxide, water and/or other components such as nitrogen, argon or sulphur containing compounds. Synthesis gas may for example be produced in a coal gasification process or a steam methane reforming process.

Synthesis gas may be used for the generation of power and/or chemicals. The generation of power and/or chemicals from synthesis gas requires the synthesis gas to be supplied with a high reliability. An interruption of the synthesis gas production, for example for maintenance, repairs and/or in case of an emergency, causes an undesirable discontinuity in synthesis gas supply to a downstream power and/or chemicals production unit.

In addition, the demand for power and/or chemicals, and consequently the demand for synthesis gas, may fluctuate in time. For example, the demand for power may be higher during daytime and/or in the winter season and lower during nighttime and/or in the summer season.

In the prior art several methods are described that address problems relating to synthesis gas supply and/or fluctuation in synthesis gas demand.

US2007/0137107 describes a process wherein up to 100 volume percent of a humidified syngas stream is passed to a water-gas shift reactor and up to 100 volume percent of the shifted syngas is converted into a chemical during a period of off-peak power demand. Also up to 100 volume percent of the humidified syngas stream is passed to a power producing process during a period of peak power demand. The process described in US2007/0137107, however, cannot solve any problems due to a discontinuity in synthesis gas supply. When the production of synthesis gas has to be discontinued, for example because of maintenance, repairs and/or in case of an emergency, the downstream water-gas shift reaction and/or power producing process have to be discontinued too.

U.S. Pat. No. 4,353,214 describes a method for efficiently storing and retrieving surplus energy produced by one or more electric utility plants. In FIGS. 5 and 6 of U.S. Pat. No. 4,353,214 reversible reformation and methanation reactions are shown. During a storage cycle, methane rich working fluid is transferred from a low-pressure cavern to a reformation reaction chamber. The heat for this reaction is provided by electrical output of an electric utility system during off-peak periods. The reaction products carbon monoxide and hydrogen are cooled and compressed and passed for storage to a high-pressure cavern, pending occurrence of a peak demand period. During a power generation cycle, the carbon monoxide and hydrogen comprising fluid is released from the high-pressure cavern to a reactor where an exothermic methanation reaction occurs. The expanded fluid drives a turbine and generator combination to yield the supplemental peak power requirement. U.S. Pat. No. 4,353,214 further describes that naturally occurring or mined caverns can be adapted for use in the invention. Existing salt mines are mentioned as an example. The process described in U.S. Pat. No. 4,353,214, however, merely uses the synthesis gas as part of the energy storage system. The synthesis gas does not leave this energy storage system. The synthesis gas is only temporarily converted into methane, i.e. during a period of peak power demand, and is converted back into synthesis gas in an off-peak period. The process does not provide a process for continuous synthesis gas supply. A further disadvantage of the method described in U.S. Pat. No. 4,353,214 is the complex hardware needed for the process.

Higman and van der Burgt in their handbook “Gasification” (Elsevier, 2003) chapter 7, paragraph 7.3.6, indicate that following the fluctuating grid demand for electricity is a problem as old as power stations. One of the solutions mentioned by Higman and van der Burgt is storing energy in such a way that the power station can run continuously while following the demand pattern. Higman and van der Burgt mention various options for energy storage such as flywheels, magneto-hydrodynamic rings, reversible chemical reactions, pressurized air in underground strata and hydro. According to them only the latter has become commercially successful.

It would be an advancement in the art to have an improved method and/or system for supplying synthesis gas that allows downstream processing units using the synthesis gas to run continuously while following the demand pattern, independently from fluctuations and/or discontinuities in the synthesis gas production.

### SUMMARY OF THE INVENTION

Such an improved method and/or system has now been provided.

Accordingly, the present invention provides a method for supplying synthesis gas comprising

a) reacting a carbonaceous feed with an oxidant, to generate synthesis gas;
b) forwarding all or part of the synthesis gas generated in step a) to an underground storage location, to generate a synthesis gas buffer; and
c) retrieving synthesis gas from the underground storage location and supplying the retrieved synthesis gas to a downstream processing unit, which downstream processing unit is substantially continuously converting synthesis gas.

The method according to the invention allows downstream processing units using the synthesis gas to run continuously while following their demand pattern, independently from fluctuations and/or discontinuities in the synthesis gas production. The method according to the invention generates a substantially continuous supply of synthesis gas to any process, unit or system downstream of a process, unit or system generating synthesis gas from a carbonaceous feed and an oxidant.

When a synthesis gas has been cooled and dried, for example in an acid-gas removal unit, storage in the underground storage location may cause the synthesis gas to absorb water. The amount of water that is absorbed may depend on the temperature and humidity in the underground storage location. After storage in the underground storage location the water content of the synthesis gas may therefore be increased. It has now been found that such water may be advantageously used when the synthesis gas is first forwarded to a water-gas shift unit before it is being forwarded to any downstream processing unit that is substantially continuously converting the synthesis gas.

Accordingly the present invention further provides a system for supplying synthesis gas comprising:

a) a gasification unit, for generating synthesis gas from a carbonaceous feed and an oxidant, that is at least directly or indirectly connected to an underground storage location;
b) an underground storage location, for generating a synthesis gas buffer, that is at least connected directly or indirectly to the gasification unit and at least connected directly or indirectly to a water-gas shift unit; and
c) a water-gas shift unit, for generating a shifted synthesis gas, that is at least connected directly or indirectly to the underground storage location.

With this system according to the invention water absorbed by, preferably cooled and dried, synthesis gas during storage in an underground storage location can advantageously be used to generate a higher molar ratio of hydrogen to carbon monoxide in a shifted synthesis gas or to reduce the amount of water that needs to be added in the water-gas shift unit.

### BRIEF DESCRIPTION OF THE DRAWINGS

FIG. 1 schematically shows a process and system according to the invention.

### DETAILED DESCRIPTION OF THE INVENTION

By a carbonaceous feed is understood a feed comprising carbon in some form. The carbonaceous feed in step a) may be any carbonaceous feed known by the skilled person to be suitable for the generation of synthesis gas. The carbonaceous feed may comprise solids, liquids and/or gases. Examples include natural gas, methane, coal, such as lignite (brown coal), bituminous coal, sub-bituminous coal, anthracite, bitumen, oil shale, oil sands, heavy oils, peat, biomass, petroleum refining residues, such as petroleum coke, asphalt, vacuum residue, or combinations thereof. In an advantageous embodiment, the carbonaceous feed is a solid and comprises coal or petroleum coke.

The use of the method and/or the system according to the invention in combination with a coal gasification process is especially advantageous because the reliability of a coal gasification unit may be less than the reliability of for example a steam methane reforming unit. In a coal gasification unit an interruption of the synthesis gas production may occur more frequently than in a steam methane reforming unit. Therefore the need for storage of the synthesis gas generated by a coal gasification process in order to allow a continuous supply of synthesis gas to a downstream processing unit, such as a gas turbine for the generation of power or a chemical-producing-plant, may be higher.

If the carbonaceous feed is a solid, such as coal, the solid carbonaceous feed may for example be supplied to a gasification reactor in the form of a slurry with water or liquid carbon dioxide or in the form of a powder with a carrier gas. Examples of suitable carrier gasses include nitrogen, carbon dioxide, recycled synthesis gas or mixtures thereof. The use of a carrier gas is for example described in WO-A-2007042562.

The oxidant in step a) may be any compound capable of oxidizing a carbonaceous feed. The oxidant may for example comprise oxygen, air, oxygen-enriched air, water (for example in a steam reforming reaction of methane or natural gas), carbon dioxide (in a reaction to generate carbon monoxide) or mixtures thereof. If an oxygen-containing gas is used as oxidant, the oxygen-containing gas used may be pure oxygen, mixtures of oxygen and steam, mixtures of oxygen and carbon dioxide, mixtures of oxygen and air or mixtures of pure oxygen, air and steam.

In a special embodiment the oxidant is an oxygen-containing gas containing more than 80 vol %, more than 85 vol %, more than 90 vol %, more than 95 vol % or more than 99 vol % oxygen. Substantially pure oxygen is preferred. Such substantially pure oxygen may for example be prepared by an air separation unit (ASU).

The oxidant used may be heated before being contacted with the carbonaceous feed, for example to a temperature of from about 50 to 300° C.

In some gasification processes, a temperature moderator may also be introduced into the reactor. Suitable moderators include steam and carbon dioxide.

The synthesis gas may be generated by reacting the carbonaceous feed with the oxidant according to any method known in the art. For example it may be generated by a gasification reaction in a gasification process or by a reforming reaction in a steam reforming process. In one embodiment the synthesis gas in step a) may be generated by steam reforming of a carbonaceous feed such as a natural gas or methane with water in a steam reforming reactor. In another embodiment the synthesis gas in step a) may be generated by an at least partial oxidation of a carbonaceous feed such as coal with an oxygen-containing gas in a gasification reactor.

In a preferred embodiment the reaction of a carbonaceous feed with an oxidant in step a) comprises a partial oxidation of a carbonaceous feed such as coal or petroleum coke with an oxygen-containing gas in a gasification reactor.

Synthesis gas leaving a gasification reactor is sometimes also referred to as raw synthesis gas. This raw synthesis gas may be cooled and cleaned in a number of downstream cooling and cleaning steps. The total of the gasification reactor and the cooling and cleaning steps is sometimes also referred to as gasification unit.

Examples of suitable gasification processes, reactors for such gasification processes and gasification units are described in “Gasification” by Christopher Higman and Maarten van der Burgt, published by Elsevier (2003), especially chapters 4 and 5 respectively. Further examples of suitable gasification processes, reactors and units are described in US2006/0260191, WO2007125047, US20080172941, EP0722999, EP0661373, US20080142408, US20070011945, US20060260191 and U.S. Pat. No. 6,755,980.

In a preferred embodiment step a) comprises a so-called entrained-flow gasification process as described in “Gasification” by C. Higman and M. van der Burgt, 2003, Elsevier Science, Chapter 5.3, pages 109-128.

The reaction of the carbonaceous feed with the oxidant in step a) may be carried out at any temperature or pressure known by the skilled person to be suitable for this purpose.

When the reaction in step a) comprises a partial oxidation of a carbonaceous feed such as coal with an oxygen-containing gas in a gasification reactor, such partial oxidation is preferably carried out at a temperature in the range from 1000° C. to 2000° C., more preferably at a temperature in the range from 1200° C. to 1800° C. The partial oxidation is further preferably carried out at a pressure from 10 to 70 bar, more preferably from 20 to 60 bar, even more preferably from 25 to 50 bar.

The synthesis gas generated by the reaction in step a) comprises hydrogen and carbon monoxide and can further comprise other components such as carbon dioxide and sulphur containing compounds such as hydrogensulphide and carbonylsulphide.

The synthesis gas generated in step a) may be cooled and cleaned before being passed to an underground storage location. Synthesis gas leaving a gasification reactor can for example be cooled by direct quenching with water or steam, direct quenching with recycled synthesis gas, heat exchangers or a combination of such cooling steps, to generate a cooled synthesis gas. In the heat exchangers, heat may be recovered. This heat may be used to generate steam.

Slag and/or other molten solids that may be present in the generated synthesis gas can suitably be discharged from the lower end of a gasification reactor.

Cooled synthesis gas can be subjected to a dry solids removal, such as a cyclone or a high-pressure high-temperature ceramic filter, and/or a wet scrubbing process, to generate a cleaned synthesis gas.

In step b), preferably cooled and cleaned, synthesis gas generated in step a) is forwarded to an underground storage location to generate a synthesis gas buffer. By a synthesis gas buffer is understood an amount of synthesis gas that is stored for later use.

The synthesis gas in step b) may be stored at any temperature or pressure known by the skilled person to be suitable for this purpose.

The synthesis gas may be stored in the underground storage location at a pressure which is higher than, equal to, or lower than the pressure at which the synthesis gas is generated in step a).

Further the synthesis gas may subsequently be used in a downstream processing unit at a pressure which is higher than, equal to, or lower than the pressure at which the synthesis gas is stored in the underground storage location.

In a preferred embodiment the synthesis gas is compressed after its generation in step a) and stored in the underground storage location at a higher pressure than the pressure at which it was generated. In this embodiment, the synthesis gas may or may not be decompressed again after its retrieval from the underground storage location and supplied to the downstream processing unit at a pressure lower than, or nearly equal or equal to, the pressure at which it was retrieved. A control valve can regulate the exact pressure of the synthesis gas supply to the downstream processing unit.

In another preferred embodiment the synthesis gas is stored in the underground storage at a pressure that is lower than, nearly equal or equal to the pressure at which the synthesis gas was generated in step a). In this embodiment, the synthesis gas may be compressed after its retrieval from the underground storage location and supplied to the downstream processing unit at a higher pressure than the pressure at which it was retrieved.

The synthesis gas is preferably stored in the underground storage location under a pressure in the range from 10 to 400 bar, preferably in the range form 30 to 200 bar and more preferably in the range from 50 to 150 bar, and most preferably in the range from 70 to 100 bar.

In an especially preferred embodiment the synthesis gas is generated in a reaction of a carbonaceous feed, such as coal, with an oxidant at a pressure in the range from 20 to 70 bar or more preferably a pressure in the range from 30 to 50 bar. Subsequently the synthesis gas may be compressed to a pressure in the range from 50 to 150 bar, more preferably in the range from 70 to 100 bar, in a compressor and stored in the underground storage location at such higher pressure. Hereafter the pressure of the synthesis gas may be lowered again to a pressure in the range from 50 to 80 bar, in order to make it suitable for use in a downstream processing unit, such as a low pressure methanol production unit.

The synthesis gas may be stored in the underground storage location at a temperature which is higher than, equal to, or lower than the temperature at which the synthesis gas is generated in step a).

Further the synthesis gas may subsequently be used in a downstream processing unit at a temperature which is higher than, equal to, or lower than the temperature at which the synthesis gas is stored in the underground storage location.

The synthesis gas is preferably stored in the underground storage location at the temperature of its surroundings, suitably at a temperature in the range from 0° C. to 200° C., preferably at a temperature in the range from 0° C. to 100° C. and more preferably at a temperature in the range from 5° C. to 80° C. In a further preferred embodiment the synthesis gas is heated again after retrieval from the underground storage location and before use in a downstream processing unit.

The underground storage location is preferably an underground cavity. The underground cavity may be a natural cavity or a preformed cavity. Examples of underground cavities include depleted oil and gas fields, subterranean porous rock structures, cavities in clay or shale formations, or cavities generated by mining activities or combinations thereof. In an especially preferred embodiment the underground storage location comprises one or more salt cavities, also referred to as salt domes.

One of the advantages of using an underground cavity for storage of the synthesis gas is that the costs of such underground cavity are low as it generally pre-exists before its use in the processes and/or system according to the invention.

Acid gases, such as carbon dioxide and/or sulphur containing compounds such as hydrogen sulphide and carbonyl sulphide, may be removed from the synthesis gas at one or more different stages of the process. These acid gases are preferably removed from the synthesis gas in an acid gas removal unit to produce a sweet synthesis gas. The removal of the acid gases can be carried out by so-called physical absorption and/or by a chemical solvent extraction process.

In one embodiment acid gases may be removed from, preferably cooled and cleaned, synthesis gas generated in step a) before forwarding this synthesis gas to the underground storage location in step b).

In another embodiment acid gases may be removed from synthesis gas after its retrieval from the underground storage location.

The acid gas removal unit not only removes acid gases, but also removes water present in the synthesis gas. The purified synthesis gas obtained from an acid gas removal unit is therefore cool and dry. It may for example be cooled to a temperature in the range from 5° C. to 100° C., more preferably in the range from 20° C. to 70° C. and its water content may be reduced to a water content in the range from 0 to 5 vol %, more preferably in the range from 0 to 1 vol %, or even in the range from 0 to 0.1 vol %.

During the storage in the underground storage location cooled and dried synthesis gas may take up small amounts of water and the water content of the synthesis gas may be increased. It has now been found that such water may be advantageously used when the synthesis gas is first supplied to a water-gas shift unit before it is being supplied to any downstream processing unit that is continuously converting the synthesis gas. In the water-gas shift unit the additional water absorbed during storage can react with carbon monoxide to form carbon dioxide and hydrogen.

In a preferred embodiment where the synthesis gas is a cooled and dried synthesis gas that absorbs water during storage in the underground storage location in step b), the downstream processing unit in step c) comprises a water-gas shift unit that is continuously converting synthesis gas to generate shifted synthesis gas. The shifted synthesis gas can subsequently be processed in a further downstream processing unit that is continuously converting the shifted synthesis gas into power and/or chemicals, such as methanol, ammonia or Fisher-Tropsch products.

Accordingly, in a preferred embodiment the present invention further provides a method for supplying humidified synthesis gas comprising;

a) reacting a carbonaceous feed with an oxidant, to generate synthesis gas and subsequently cooling and drying the generated synthesis gas, to generate a cooled and dried synthesis gas;
b) forwarding all or part of the cooled and dried synthesis gas generated in step a) to an underground storage location where it absorbs water, to generate a synthesis gas buffer comprising humidified synthesis gas; and
c) retrieving the humidified synthesis gas from the underground storage location and supplying the retrieved humidified synthesis gas to a water-gas shift unit, which water-gas shift unit is substantially continuously converting synthesis gas to generated shifted synthesis gas.

In an especially preferred embodiment the cooling and drying of the generated synthesis gas is carried in an acid gas removal unit, generating a sweet, cooled and dried synthesis gas. Step a) therefore preferably further comprises cooling and drying of the generated synthesis gas in an acid gas removal unit to generate a sweet, cooled and dried synthesis gas which sweet, cooled and dried synthesis gas is then forwarded in step b) to an underground storage location where it absorbs water, to generate a synthesis gas buffer comprising sweet and humidified synthesis gas; and wherein step c) further comprises retrieving the sweet and humidified synthesis gas from the underground storage location and supplying the retrieved sweet and humidified synthesis gas to a water-gas shift unit that is substantially continuously converting synthesis gas to generate shifted synthesis gas.

By a humidified synthesis gas is understood a synthesis gas that contains water. The humidified synthesis gas may or may not be saturated. In a preferred embodiment the humidified synthesis gas is not saturated with water at the temperature at which it is stored in the underground storage location. In a further embodiment the cooled and dried synthesis gas absorbs water during storage in the underground storage location and the generated humidified synthesis gas contains more water than the cooled and dried synthesis gas.

In one embodiment the humidified synthesis gas retrieved from the underground storage location may contain water and carbon monoxide in a molar ratio of water to carbon monoxide of 0.1:1 to 10:1; 0.2:1 to 5:1, or 0.5:1 to 3:1. If desired, when the water absorbed during storage in the underground storage location is considered insufficient for a water-gas shift reaction, additional water may be added in step c). Any additional water added in step c) may be added in the form of liquid water or steam.

In a preferred embodiment the shifted synthesis gas is subsequently processed in a further downstream processing unit that continuously converts the shifted synthesis gas into methanol or ammonia.

In the system provided by the present invention the gasification unit can comprise one or more inlets and at least one outlet. The gasification unit may for example comprise an inlet for a carbonaceous feed, an inlet for an oxidant and optionally an inlet for a temperature moderator. The outlet of the gasification unit may be directly or indirectly connected to an underground storage location. In a preferred embodiment the gasification unit comprises a gasification reactor and one or more cooling and/or cleaning units and the outlet of the gasification reactor is connected indirectly via the cooling and/or cleaning units to an underground storage location.

In the system provided by the present invention the underground storage location can comprise one or more inlets and one or more outlets. In one preferred embodiment the underground storage location comprises at least one inlet that is at least connected directly or indirectly to the gasification unit and at least one outlet that is connected directly or indirectly to a water-gas shift unit. In another preferred embodiment the underground storage location comprises one combined inlet/outlet that is connected directly or indirectly to both the gasification unit and the water-gas shift unit.

In the system provided by the present invention the water-gas shift unit can comprise one or more inlets and one or more outlets. In a preferred embodiment the water-gas shift unit comprises at least one inlet that is connected directly or indirectly to the underground storage location and at least one outlet that is connected directly or indirectly to a downstream processing unit.

The amount of synthesis gas forwarded to the underground storage location may vary in time. In a preferred embodiment the amount of synthesis gas forwarded to the underground storage location varies with the demand for synthesis gas downstream of step a). The exact amount of synthesis gas to be forwarded to the underground storage location may for example depend on the season of the year and the time of the day.

During a period of off-peak demand for synthesis gas and/or during a period of high generation of synthesis gas, excess synthesis gas generated in step a) for which there is no need in the downstream processing unit may be forwarded to the underground storage location. For example during a period of off-peak demand for synthesis gas and/or during a period of high generation of synthesis gas, from 0.1 vol % to 90 vol %, more preferably from 1 vol % to 80 vol %, or more preferably from 10 to 50 vol % of the synthesis gas generated in a gasification unit may be forwarded to an underground storage location. The remainder of the synthesis gas generated in step a) may be forwarded directly to the downstream processing unit. In exceptional cases, for example when a downstream unit for power generation or chemicals is shut down for maintenance or repair, all (100 vol %) of the synthesis gas prepared in step a) may be forwarded to the underground storage.

The storage of excess synthesis gas in an underground storage location during a period of off-peak demand for synthesis gas and/or during a period of high generation of synthesis gas, advantageously allows units that generate synthesis gas in step a), such as gasification units, to operate at a constant and/or maximum capacity.

During a period of peak demand for synthesis gas and/or during a period of discontinuity in generation or low generation of synthesis gas, no synthesis gas or only a small amount of synthesis gas may be forwarded to the underground storage location. For example from 0 vol % to 1 vol %, or from 0.0001 vol % to 0.1 vol %, of the synthesis gas produced may be forwarded. In a preferred embodiment no synthesis gas is forwarded. During such periods all or nearly all synthesis gas produced, if any, is directly forwarded to the downstream processing unit that is converting synthesis gas. During such a period of peak demand for synthesis gas and/or during such a period of discontinuity in generation or low generation of synthesis gas, synthesis gas stored in the underground storage location may be retrieved and forwarded to the downstream processing unit. In a convenient embodiment the synthesis gas retrieved from the underground storage location is mixed with synthesis gas generated in step a) that has not been stored, if any is available, and the mixture is forwarded to the downstream processing unit.

The amount of synthesis gas retrieved from the underground storage location may vary in time. In a preferred embodiment the amount of synthesis gas retrieved from the underground storage location varies with the demand for synthesis gas. The exact amount of synthesis gas to be retrieved from the underground storage location may depend on the season of the year and the time of the day.

During a period of off-peak demand for synthesis gas and/or during a period of high generation of synthesis, no synthesis gas or only a small amount of synthesis gas may be retrieved from the underground storage location. During a period of peak demand for synthesis gas and/or during a period of discontinuity in generation or low generation of synthesis gas, the amount of synthesis gas retrieved from underground storage location may be higher. For example, during a period of peak demand and/or during a period of discontinuity in generation or low generation of synthesis gas, from 0.01 vol % to 100 vol %, more preferably from 1 vol % to 90 vol %, even more preferably 1 vol % to 80 vol %, still even more preferably from 1 vol % to 50 vol % or even more preferably from 2 vol % to 40 vol % of the total amount of synthesis gas forwarded to a downstream processing unit may be retrieved from the underground storage location. For practical reasons it may be advantageous to retrieve at least 5 or preferably at least 10 vol % of the total amount of synthesis gas forwarded to a downstream processing unit from the underground storage location.

In some cases, for example when a unit generating the synthesis gas, such as a gasification unit or a steam methane reformation unit, needs to shut down for maintenance, repairs and/or in case of an emergency, even 100 vol % of the synthesis gas forwarded to a downstream processing unit may be retrieved from the underground storage location. In this case the feed to a downstream processing unit of synthesis gas consists completely of synthesis gas retrieved from the underground storage location. By using the synthesis gas retrieved from the underground storage location, any downstream processing of synthesis gas in any downstream power producing or chemical producing facility does not need to be interrupted.

As a coal gasification unit is more often in need of maintenance than for example a steam methane reforming unit, the processes according to the invention are especially advantageous for coal gasification units.

In an especially preferred embodiment step b) is therefore carried out during a period of off-peak demand for synthesis gas and/or during a period of high generation of synthesis gas; and/or step c) is carried out during a period of peak demand for synthesis gas and/or during a period of discontinuity in generation or low generation of synthesis gas.

The present invention also provides a method wherein during a period of off-peak demand for synthesis gas and/or a period of high generation of synthesis gas, a part of the synthesis gas generated in step a) is passed to an underground storage location in step b) and wherein during a period of peak demand for synthesis gas and/or a period of low generation of synthesis gas, another part of the synthesis gas generated in step a) is mixed with retrieved synthesis gas in step c) and supplied to a downstream processing unit.

When synthesis gas retrieved from the underground storage location is mixed with synthesis gas that has not been stored in the underground storage location, the weight ratio of stored synthesis gas to non-stored synthesis gas may vary widely depending on the need for additional synthesis gas at any specific time. Such ratio of stored synthesis gas to non-stored synthesis gas may, for example, range from 0.001:1 to 10:1, 0.01:1 to 5:1 or 0.1:1 to 1:1.

In step c) the retrieved synthesis gas is supplied to a downstream processing unit that is substantially continuously converting synthesis gas. By a substantially continuously conversion is understood a continuous conversion, with the exception of any maintenance, repairs and/or in case of an emergency for the downstream processing unit. The downstream processing unit converting synthesis gas in step c) can operate independently from the synthesis gas generation in step a).

The downstream processing unit to which the retrieved synthesis gas is supplied may be any downstream processing unit that is known by the skilled person to process synthesis gas. Examples of a downstream processing unit include a gas turbine or combined cycle for power generation; a plant that converts synthesis gas into chemicals such as methanol or ammonia; and a Fisher-Tropsh plant that converts synthesis gas into Fisher-Tropsh liquids.

In an advantageous embodiment therefore step b) is carried out during a period of off-peak demand for power and/or chemicals and/or step c) is carried out during a period of peak demand for power and/or chemicals.

The downstream processing unit may comprise a water-gas shift unit wherein carbon monoxide present in the synthesis gas may react with water in the synthesis gas or water added to the water-gas shift unit.

As the water-gas shift reaction is equilibrium-limited, increasing the concentration of water in the synthesis gas advantageously shifts the conversion towards a higher hydrogen production. In some embodiments the shifted synthesis gas may contain hydrogen and carbon monoxide in a molar ratio of hydrogen to carbon monoxide of 0.2:1 to 500:1; 0.5:1 to 50:1, or 1:1 to 5:1. A molar ratio of hydrogen to carbon monoxide in the range from 1:1 to 3:1 may be especially suitable. For example for downstream use of the synthesis gas to prepare methanol a molar ratio of hydrogen to carbon monoxide of about 2:1 may be useful; for downstream use of the synthesis gas to carry out a fixed bed Fisher-Tropsch synthesis a molar ratio of hydrogen to carbon monoxide of about 2:1 may be useful; for downstream use of the synthesis gas to prepare vinyl acetate or methyl acetate a molar ratio of hydrogen to carbon monoxide of about 1.25:1 to 2:1 may be useful. For downstream use of the synthesis gas to prepare power the synthesis gas may be treated to generate pure or nearly pure hydrogen.

In one further embodiment shifted synthesis gas, especially if such synthesis gas has not been treated in an acid gas removal unit before, may subsequently be passed to an acid gas removal unit to remove or reduce the concentration of sulphur containing compounds and/or carbon dioxide. Examples of possible sulphur containing compounds that may be present in the shifted synthesis gas include hydrogen sulphide, sulphur dioxide, sulphur trioxide, sulphuric acid, elemental sulphur, carbonyl sulphide, and mercaptans.

The shifted synthesis gas may be used for the production of power and/or chemical compounds such as methanol.

In a special embodiment the process according to the invention comprises a further step wherein synthesis gas is treated to separate hydrogen and/or carbon monoxide from the remainder of the synthesis gas. It may be especially advantageous to separate hydrogen from the supplied synthesis gas in step c). Hydrogen may be separated from the synthesis gas by any method known in the art. In an advantageous embodiment hydrogen is separated from the synthesis gas by pressure swing absorption (PSA). The PSA unit can split the synthesis gas into a carbon monoxide-rich stream and a hydrogen-rich stream. The separated hydrogen can subsequently be used for the generation of power or the preparation of chemical compounds such as ammonia.

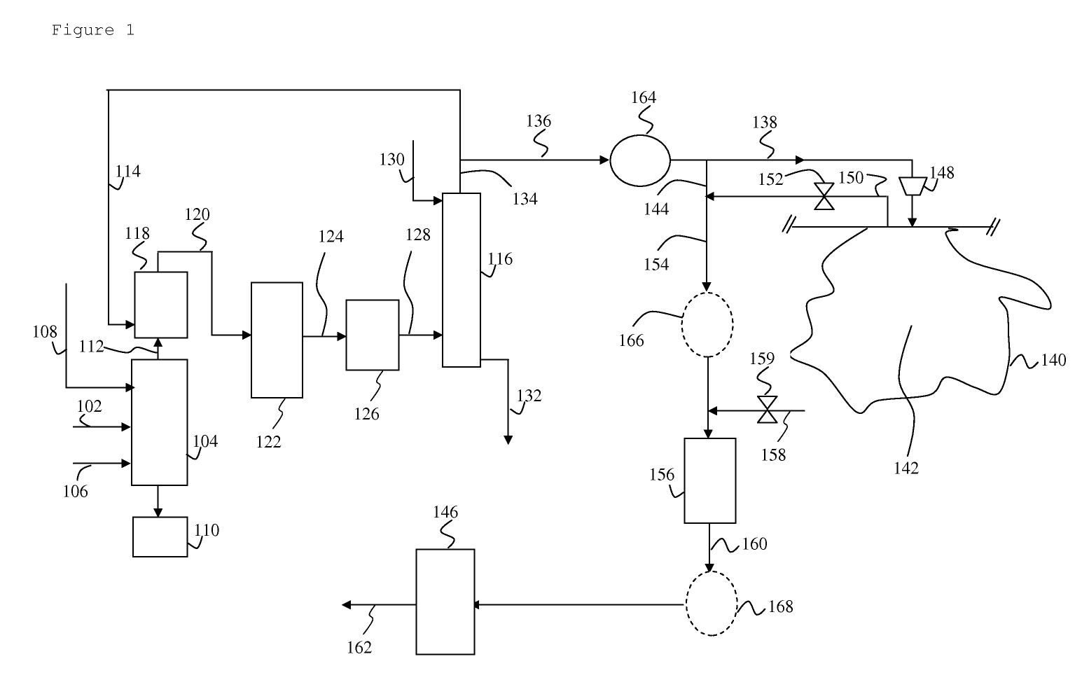

In FIG. 1, a stream of solid carbonaceous feed (102), for example finely ground coal, is introduced into a gasification reactor (104). (The carbonaceous feed may be prepared in a grinding mill and brought to an elevated pressure by means of a sluice system, lock hoppers or a solids pump not shown in the FIGURE). A stream of oxidant (106), for example a stream of oxygen rich gas originating for example from a air separation plant, is also introduced into the reactor (104). Optionally a stream of moderator (108), such as steam or carbon dioxide, may also be supplied to the reactor (104). In the gasification reactor (104), the solid carbonaceous feed (102) is partially oxidized to generate a raw synthesis gas. The raw synthesis gas may have a pressure of about 40 bar. Such raw synthesis gas may contain hydrogen, carbon monoxide, carbon dioxide, sulphur-containing compounds, and water. The raw synthesis gas may further contain slag particles. The majority of the slag particles may leave the gasification reactor via the bottom as molten slag and may be quenched and scattered to small glassy granulates in a water bath (110). A stream of raw synthesis gas (112) is withdrawn from the top of the gasification reactor (104).

The stream of raw synthesis gas (112) may be quenched with a stream of recycled synthesis gas (114) taken from the inlet (not shown) and/or outlet of the wet scrubber (116) in a quench section (118), producing a stream of diluted synthesis gas (120). The gasification reactor (104) and quench section (118) may be situated in the same vessel or in two separate vessels.

The stream of diluted synthesis gas (120) is cooled in a cooler (122), producing a stream of cooled synthesis gas (124). In the cooler (122), the stream of diluted synthesis gas (120) may for example be cooled by heat-exchangers (not shown in the FIGURE), such as a waste heat boiler (not shown in the FIGURE), or by injecting water into the stream of diluted synthesis gas (not shown in the FIGURE) such as described in US 2006/0260191. The gasification reactor (104), the quench section (118), the pipe between the quench section (118) and the cooler (122) and/or, if present the duct between the gasification reactor (104) and the quench section (118), may be provided with a cooled channel as illustrated in US 2006/0260191.

The stream of cooled synthesis gas (124) may subsequently be treated in a dry solids removal section (126) to remove ash carried with the stream of cooled synthesis gas (124). For this purpose the dry solids removal section (126) may for example contain one or more cyclones (not shown) and/or a high-pressure high-temperature ceramic filter (not shown).

The stream of cooled synthesis gas from which the ash has been removed (128) may subsequently be treated in a wet scrubber (116), where this synthesis gas stream is contacted with a countercurrent flow of water entering the wet scrubber (116) from the top (130) and leaving the wet scrubber (116) at the bottom (132). In this wet scrubber (116) halogen compounds and the last residues of solid slag particles are removed from the synthesis gas. A stream of clean synthesis gas (134) is withdrawn from the top of the wet scrubber (116). Part of this stream of clean synthesis gas (134) may be recycled to the quench section (118) via a stream of recycled synthesis gas (114). Another part of the stream of clean synthesis gas (134) may be forwarded as a product stream of synthesis gas (136).

During a period of off-peak demand for synthesis gas and/or during a period of high supply of synthesis gas, part of the product stream of synthesis gas (136) may be forwarded via stream (138) to an underground storage location (140), in the exemplified case a salt cavity, to generate a synthesis gas buffer (142), and another part of the synthesis gas may be forwarded via a stream (144) towards a downstream processing unit (146) that is substantially continuously converting the synthesis gas. Before being stored in the underground storage location (140), the synthesis gas in stream (138) may be compressed to a pressure of 70-100 bar by a compressor (148).

During a period of peak-demand for synthesis gas and/or during a period of low supply of synthesis gas, synthesis gas is retrieved from the underground storage location (140) via stream (150). The pressure in stream (150) is regulated via valve (152). The retrieved synthesis gas in stream (150) may be combined with synthesis gas in stream (144), and the combined synthesis gas may be forwarded via a stream (154) towards the downstream processing unit (146) that is substantially continuously converting the synthesis gas.

The synthesis gas in stream (154) that is forwarded towards the downstream processing unit (146) may be shifted to a higher molar ratio of hydrogen to carbon monoxide in a water-gas shift reactor (156) before being forwarded to the downstream processing unit (146). The synthesis gas and a stream of liquid water and/or steam (158) via valve (159) may be reacted in a water-gas shift reactor (156) to produce a stream of shifted synthesis gas (160). The stream of shifted synthesis gas (160) can subsequently be forwarded to the downstream processing unit (146). The downstream processing unit (146) can for example generate a stream of methanol (162).

Acid gasses such as carbon dioxide and sulphur containing compounds such as hydrogen sulphide or carbonyl sulphide may be removed from the product stream of synthesis gas (136) in an acid gas removal unit (164) located before storage in the underground storage location (140). In this case, the acid gas removal unit (164) will cause the synthesis gas that is forwarded to the underground storage location (140) to be sweet, cool and dry. Such sweet, cool and dry synthesis gas may absorb water during storage in the underground storage location (140). This water may advantageously be converted to additional hydrogen in and/or may advantageously reduce the amount of liquid water and/or steam that needs to be added to the water-gas shift reactor (156).

In alternative embodiments (shown by dotted ovals in the FIGURE) acid gasses such as carbon dioxide and sulphur containing compounds such as hydrogen sulphide or carbonyl sulphide may be removed in an acid removal unit (166) from the synthesis gas in stream (154) or in an acid removal unit (168) from stream of shifted synthesis gas (160).

What is claimed is:

1. A method for supplying synthesis gas comprising
a) reacting a carbonaceous feed with an oxidant, to generate synthesis gas;
b) forwarding all or part of the synthesis gas generated in step a) to an underground storage location, to generate a synthesis gas buffer; and
c) retrieving synthesis gas from the underground storage location and supplying the retrieved synthesis gas to a downstream processing unit, which downstream processing unit is substantially continuously converting synthesis gas.

2. The method according to claim 1, wherein the carbonaceous feed comprises coal or petroleum coke.

3. The method according to claim 1, wherein the reaction of a carbonaceous feed with an oxidant in step a) comprises a partial oxidation of coal or petroleum coke with an oxygen-containing gas in a gasification reactor.

4. The method according to claim 1, wherein the synthesis gas generated in step a) is compressed and stored in the underground storage location at a higher pressure than the pressure at which it was generated.

5. The method according to claim 1, wherein the synthesis gas generated in step a) is stored in the underground storage at a pressure that is lower than, nearly equal or equal to the pressure at which the synthesis gas was generated; and the retrieved synthesis gas in step c) is compressed and supplied to the downstream processing unit at a higher pressure than the pressure at which it was retrieved.

6. The method according to claim 1, wherein the underground storage location comprises one or more salt cavities.

7. The method according to claim 1, wherein the downstream processing unit comprises a water-gas-shift reactor.

8. The method according to claim 1, wherein
step a) further comprises cooling and drying of the generated synthesis gas to generate a cooled and dried synthesis gas, which cooled and dried synthesis gas is then forwarded in step b) to an underground storage location where it absorbs water, to generate a synthesis gas buffer comprising humidified synthesis gas; and
wherein step c) further comprises retrieving the humidified synthesis gas from the underground storage location and supplying the retrieved humidified synthesis gas to a water-gas shift unit that is substantially continuously converting synthesis gas to generate shifted synthesis gas.

9. The method according to claim 8, wherein step a) further comprises cooling and drying of the generated synthesis gas in an acid gas removal unit to generate a sweet, cooled and dried synthesis gas which sweet, cooled and dried synthesis gas is then forwarded in step b) to an underground storage location where it absorbs water, to generate a synthesis gas buffer comprising sweet and humidified synthesis gas; and wherein step c) further comprises retrieving the sweet and humidified synthesis gas from the underground storage location and supplying the retrieved sweet and humidified synthesis gas to a water-gas shift unit that is substantially continuously converting synthesis gas to generate shifted synthesis gas.

10. A method for supplying humidified synthesis gas comprising;
a) reacting a carbonaceous feed with an oxidant, to generate synthesis gas and subsequently cooling and drying the generated synthesis gas to generate a cooled and dried synthesis gas;
b) forwarding all or part of the cooled and dried synthesis gas generated in step a) to an underground storage location where it absorbs water, to generate a synthesis gas buffer comprising humidified synthesis gas; and
c) retrieving the humidified synthesis gas from the underground storage location and supplying the retrieved humidified synthesis gas to a water-gas shift unit, which water-gas shift unit is substantially continuously converting synthesis gas to generated shifted synthesis gas.

11. The method according to claim 1, wherein step b) is carried out during a period of off-peak demand for synthesis gas and/or during a period of high generation of synthesis gas; and/or step c) is carried out during a period of peak demand for synthesis gas and/or during a period of discontinuity in generation or low generation of synthesis gas.

12. The method according to claim 1, wherein during a period of off-peak demand for synthesis gas and/or a period of high generation of synthesis gas, a part of the synthesis gas generated in step a) is passed to an underground storage location in step b) and wherein during a period of peak demand for synthesis gas and/or a period of low generation of synthesis gas, another part of the synthesis gas generated in step a) is mixed with retrieved synthesis gas in step c) and supplied to a downstream processing unit.

13. The method according to claim 1, wherein the downstream processing unit is a gas turbine or combined cycle for power generation; a plant that converts synthesis gas into methanol or ammonia; or a Fisher-Tropsh plant that converts synthesis gas into Fisher-Tropsh liquids.

14. The method according to claim 1, comprising a further step wherein synthesis gas is treated to separate hydrogen and/or carbon monoxide from the remainder of the synthesis gas.

15. A system for supplying synthesis gas comprising:
a) a gasification unit, for generating synthesis gas from a carbonaceous feed and an oxidant, that is at least directly or indirectly connected to an underground storage location;
b) an underground storage location, for generating a synthesis gas buffer, that is at least connected directly or indirectly to the gasification unit and at least connected directly or indirectly to a water-gas shift unit; and
c) a water-gas shift unit, for generating a shifted synthesis gas, that is at least connected directly or indirectly to the underground storage location.
